(19) United States
(12) Patent Application Publication
(10) Pub. No.: US 2008/0107575 A1
(43) Pub. Date: May 8, 2008

(54) Apparatus and process for reacting fluid over catalyst bed

(76) Inventors: Michael J. Vetter, Schaumburg, IL (US); William J. Koves, Hoffman Estates, IL (US); Steven M. Poklop, Palatine, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/007,123

(22) Filed: Dec. 8, 2004

(51) Int. Cl. B01J 8/02

(52) U.S. Cl. 422/211

(57) ABSTRACT

A radial flow reactor and process for reacting fluid is disclosed. The reactor includes a series of peripheral inlet distributor members which direct fluid flow radially inwardly to an annular catalyst bed. Each inlet distributor member includes an elongate body defining an interior, the body including a screen wall facing the catalyst bed; an opposing outer wall spaced radially outwardly from screen wall, an inlet to introduce fluid into the interior; and a perforated baffle wall positioned between the outer wall and screen wall. The perforated baffle wall divides the interior into a first chamber for guiding flow from the inlet in an axial direction along the elongate body and a second chamber for guiding flow radially inwardly from the baffle wall toward the screen wall. The baffle wall is effective to reduce a pressure gradient along the screen, thereby improving flow uniformity and optimizing use of catalyst material.

### FIELD OF THE INVENTION

The invention relates to apparatus of the type wherein a gas or liquid is treated or reacted over a bed of contact material such as catalyst, and the invention particularly relates to a radial flow reactor.

### BACKGROUND OF THE INVENTION

Radial flow reactors are widely used to contact fluid reactants that are typically gaseous with particulate catalyst. Radial flow reactors typically include a cylindrical vessel with a main inlet duct at one end and an annular chamber or series of chambers arranged annularly around the interior periphery of the vessel for distributing reactants to an annular catalyst bed disposed inwardly of the reactant distribution chamber(s). A central outlet pipe is disposed inwardly of the annular catalyst bed and is in communication with a reactor outlet for the exit of product from the reactor. The inlet distributor member(s) and the outlet pipe are permeable to fluid flow but impermeable to catalyst flow to contain the catalyst bed therebetween.

Examples of processes carried out in such an apparatus include various hydroprocessing techniques such as catalytic reforming, hydrotreating, dehydrogenation, dehydrocyclodimerization and isomerization. Additionally, radial flow reactors can be used in continuous catalyst regeneration systems.

As mentioned above, a known type of reactor includes a series of chamber segments arranged concentrically around an outer periphery of the bed of contact material. The chamber segments are formed by a plurality of inlet distributor members. A radially-inward face of each distributor member is constructed of a screen to permit fluid flow from the chamber radially inwardly to the bed of contact material. As will be recognized by those skilled in the art, the screen is conventionally constructed of a plurality of parallel wires that are dimensioned and spaced from each other to define openings between adjacent wires so as to permit the passage of fluid and prevent individual catalyst particles from passing through the screen. These parallel wires are mounted to lateral cross members for structural support. Conventional inlet distributor members are commercially available, for example, from USF Johnson Screens under the name OPTIMISER.

A problem with conventional radial flow reactors is that internal flow resistance within the inlet distributor members results in a pressure gradient. In particular, the internal cross-members of the screen cause a fluid resistance along a height of the screen. The pressure gradient disadvantageously results in non-uniform flow distribution through the catalyst bed.

An object of the present invention is to provide a radial flow reactor that yields improved flow behavior.

Another object of the present invention is to provide a screen structure for a radial flow reactor that promotes uniform flow behavior through an annular bed of contact material.

Another object of the present invention is to provide a method of processing fluid in a reactor whereby flow uniformity through the contact material is promoted.

### SUMMARY OF THE INVENTION

Applicant has discovered a new arrangement for improving flow in a radial flow reactor. For example, in an embodiment, a radial flow reactor is provided including a vessel having a cylindrical vessel wall, the vessel having a central axis. The reactor includes an outlet pipe mounted centrally within the vessel and positioned generally along the axis. The outlet pipe has openings dimensioned to allow passage of fluid and prevent passage of catalyst particles. The reactor also includes series of inlet distributor members disposed in an array peripherally around an interior side of the cylindrical vessel wall. In an embodiment, at least one bed chamber is defined between said inlet distributor members and said outlet pipe for containing catalyst particles. Each of the inlet distributor members includes a screen wall adjacent to the catalyst bed, an outer wall generally parallel to the screen wall and spaced radially outwardly from the screen wall; and a perforated baffle wall positioned between the outer wall and screen wall, the baffle wall being spaced radially inwardly from the outer wall to define a first inlet chamber for guiding fluid flow in a generally axial direction along the inlet distributor member, baffle wall being spaced radially outwardly from the screen wall to define a second inlet chamber for guiding fluid flow from the first inlet chamber in a generally radial direction from the baffle wall toward the screen wall.

A method is also provided for reacting a fluid with a catalyst. For example, a method is provided including the steps of: (a) providing a cylindrical reactor vessel having a central outlet pipe positioned generally along on a central axis, at least one elongate inlet distributor member spaced radially outwardly from the outlet pipe to define a catalyst bed chamber between the outlet pipe and the inlet distributor member, the distributor member having a screen wall facing the catalyst bed chamber; (b) delivering a fluid to a first inlet chamber within the inlet distributor member, the first inlet chamber extending substantially along an axial length of the distributor member; (c) passing the fluid in a generally radial direction through perforations in a baffle wall to at least one second inlet chamber within the inlet distributor member; (d) passing the fluid in a generally radial direction through openings in the screen wall into the catalyst bed; (e) contacting fluid with catalyst in said catalyst bed to yield a treated fluid; and (f) recovering the treated fluid from said catalyst bed through said central outlet pipe.

Advantageously, the perforated baffle wall is effective as a means for reducing a pressure gradient at the screen along the height dimension of the inlet distributor member. As a result, the baffle wall provides improved uniformity of fluid flow through the catalyst bed, and correspondingly improved uniformity of catalyst exposure, thereby optimizing the effectiveness and useful life of the catalyst material.

In an embodiment, the baffle wall is mounted at a radially outward side of lateral cross members that support the screen members. Because the baffle wall reduces friction that would otherwise be caused by the cross members, wider cross-members may be used to advantageously achieve greater structural rigidity without increasing flow resistance.

In an embodiment, the baffle wall is generally concentric about a central axis of the reactor. The baffle wall may be formed of sheet metal, such as stainless steel.

In an embodiment, the perforations are generally slot-shaped. Each of the slot-shaped perforations preferably has a length oriented generally perpendicular to an axial direction. For example, a suitable configuration provides that each of the slot-shaped perforations has a width of about 1 mm and a length of about 12-13 mm, and multiple rows of the slots are provided at vertical increments of about 3.2 mm.

In an embodiment, each of the inlet distributors has a body that defines an interior, wherein the body includes, for example, a screen wall facing the catalyst bed, an outer wall, and a pair of opposed side panels extending between the screen wall and the outer wall.

In an embodiment, the baffle wall is mounted within the body to extend between a pair of opposed side panels extending between the screen and the outer wall.

### BRIEF DESCRIPTION OF THE DRAWINGS

FIG. 1 is schematic, sectional elevation of a radial flow reactor having features according to teachings of the present invention.

FIG. 2 is a schematic, fragmentary, perspective view of a plurality of inlet distributor members of the reactor of FIG. 1.

FIG. 3 is a sectional view of the inlet distributor members as viewed generally downwardly.

FIG. 4 is a fragmentary enlargement from the indicated area of FIG. 2, illustrating the screen members, cross members, and perforated baffle wall.

FIG. 5 is a sectional view as taken generally along line V-V of FIG. 4.

FIG. 6 is a fragmentary schematic view looking in a radially-inward direction toward the baffle wall, the view having portions broken away to show the cross-members and the screen elements.

FIG. 7 is a fragmentary schematic, sectional view of adjacent inlet distributor members, looking in an axial direction, illustrating a strip that covers an axial gap between the inlet distributor members, arrows indicating radial flow passing through the baffle wall and screen members.

### DETAILED DESCRIPTION OF THE DRAWINGS

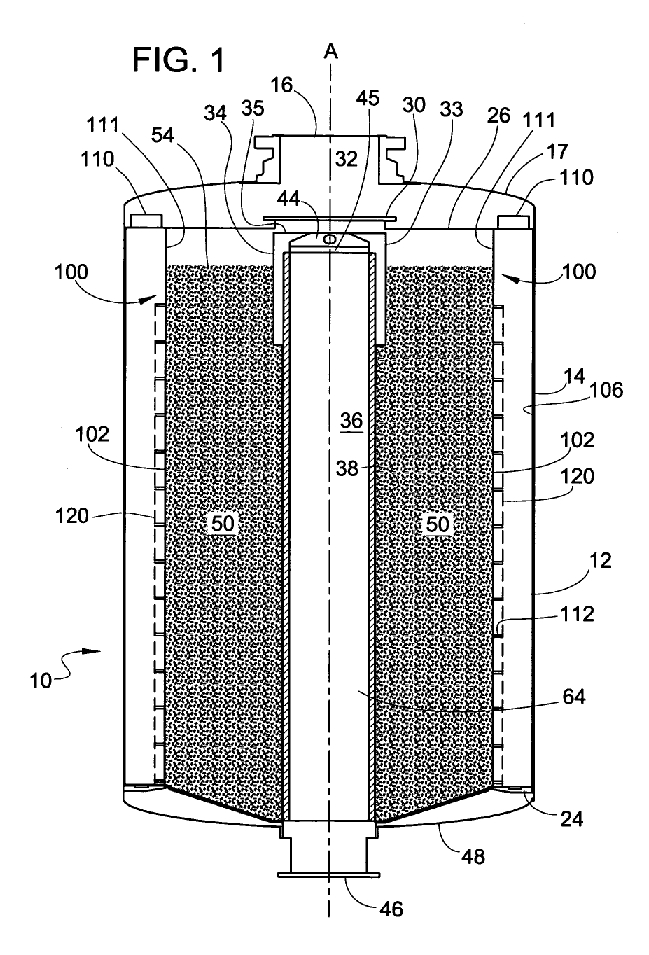

Now referring to the drawings, wherein like numerals designate like components, FIG. 1 illustrates an embodiment of an improved radial flow reactor 10 including features according to teachings of the present invention. The radial flow reactor 10 is operable to treat liquid or gaseous fluids. Although the radial flow reactor 10 depicted in the FIG. 1 is a fixed-bed reactor, the invention is equally applicable to a continuously or periodically moving bed reactor. In such a reactor, fresh or regenerated catalyst may be loaded in the top of the reactor and spent catalyst removed from the bottom of the reactor by appropriate valving and piping for transport to regeneration or other disposition of the spent catalyst.

As illustrated in FIG. 1, the radial flow reactor 10 includes a reactor vessel 12 having a vessel wall 14 which is preferably cylindrical in shape. The reactor vessel 12 includes a top head 17 having a main inlet duct 16. Fluid to be treated is introduced through the main inlet duct 16. A plurality of inlet distributor members 100 are disposed in an annular arrangement around a periphery of an interior of the reactor vessel 12. A central outlet pipe 38 is disposed along a central axis A of the reactor 10. An annular catalyst bed 50 is defined by the space between the inlet distributor members 100 and the central outlet pipe 38. The annular catalyst bed 50 contains a bed of solid catalyst particulate material. The outlet pipe 38 is in communication with an outlet duct 46 in a bottom head 48 of the reactor vessel 12.

Still referring to FIG. 1, it will be generally understood that fluid enters the reactor 10 at the main inlet duct 16, from which the top head 17 directs the fluid to a distributor port 110 of the inlet distributor members 100. The fluid exits the inlet distributor members 100 by passing through openings in the respective inner walls 102. Fluid then flows in a generally radial direction through the catalyst bed 50, into the central outlet pipe 38, and then exits the reactor 10 at the main outlet duct 46.

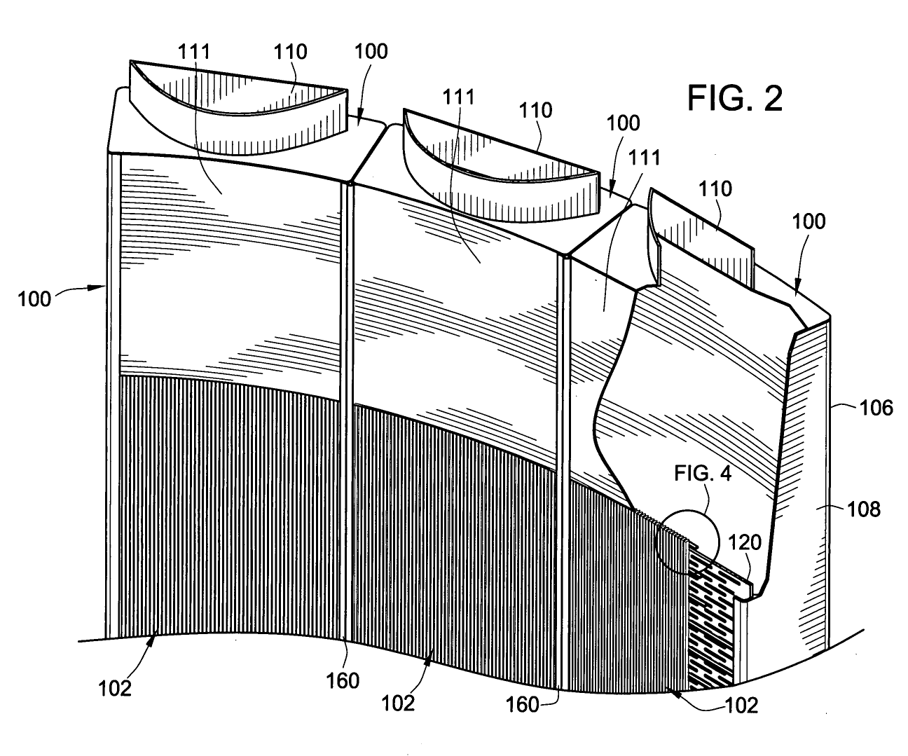

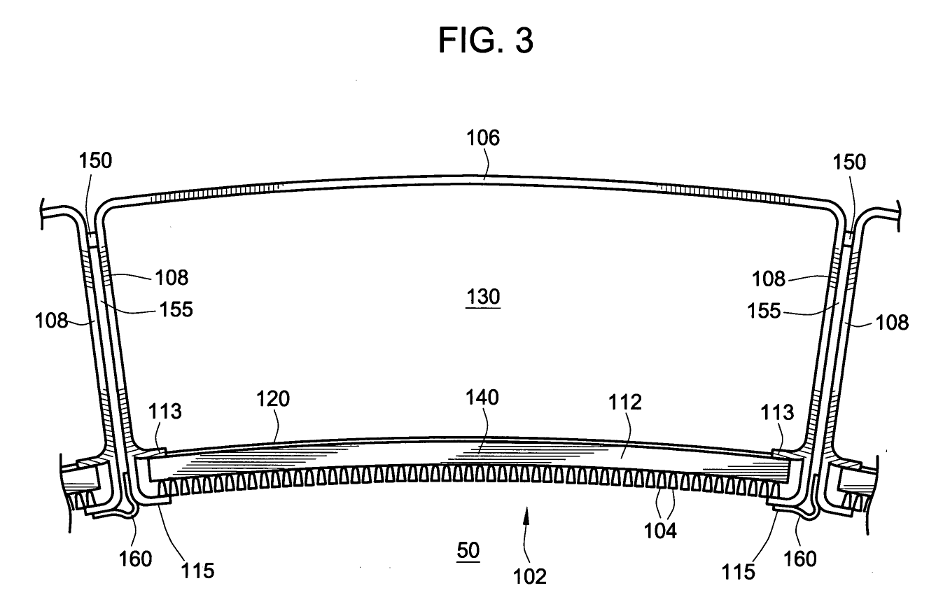

Each of the inlet distributor members 100 includes an elongate body which, in the illustrated configuration, is aligned vertically in an orientation parallel to the axis A. More particularly, with reference to FIGS. 2 and 3, each of the inlet distributor members 100 includes the inner wall 102, at least a portion of which is a screen formed by a plurality of parallel screen members 104 adjacent to the catalyst bed 50, and an outer wall 106 that is generally opposed to the inner wall 102 and spaced radially outwardly from the screen wall. Opposing side panels 108 extend between the inner wall 102 and the outer wall 106. As illustrated in FIGS. 1 and 2, a top of the inlet distributor member 100 includes the distributor port 110 that opens to an interior of the distributor member. Moreover, FIG. 2 shows barriers 111 at the radially inward top of the distributor members 100. Barriers 111 require the fluid to travel downwardly before entering catalyst bed 50 through inner wall 102.

As can be seen in FIG. 3, in a preferred embodiment, each of the inner walls 102 and the outer walls 106 is arcuate in shape, in a manner concentric around the central axis A (FIG. 1). The outer wall 106 is disposed adjacent the vessel wall 14.

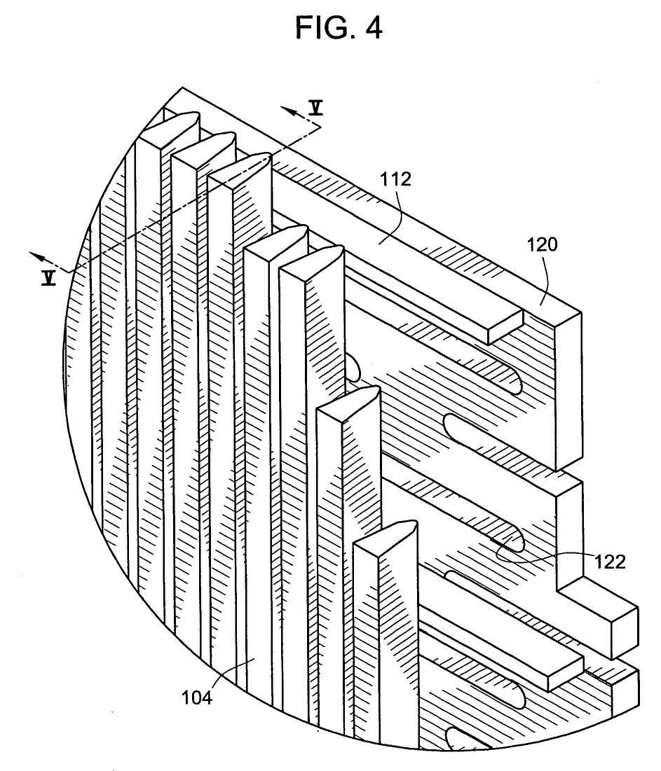

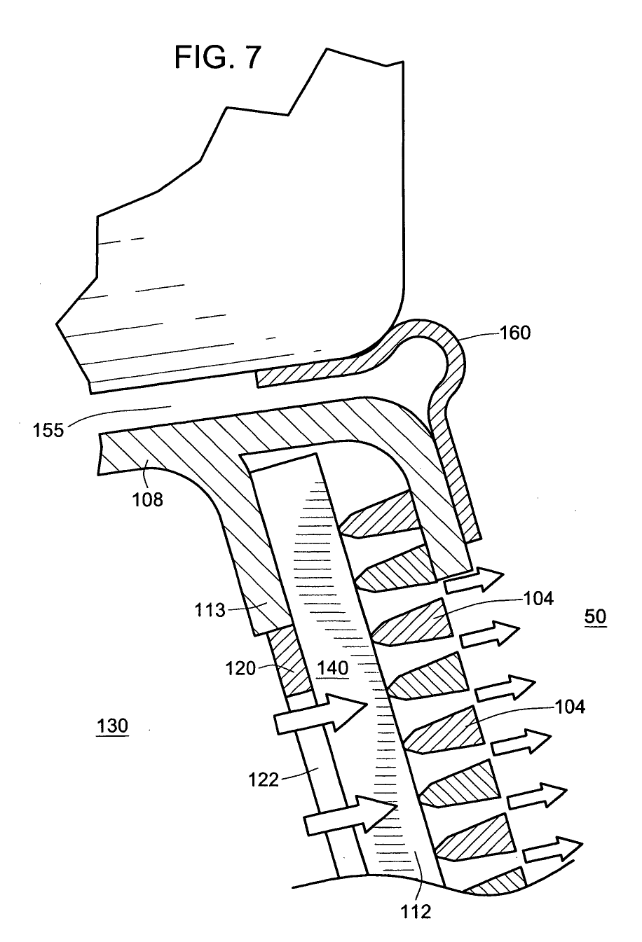

Turning to FIG. 4, the screen members 104 are spaced apart to define openings dimensioned to permit the passage of fluid and to prevent the passage of particulate solids, such as catalyst particles. In order to provide a rigid structure to support the screen members 104. The inlet distributor member 100 includes a plurality of lateral cross members 112 that extend horizontally between the opposing side panels 108 (FIG. 3). The screen members 104 are mounted to a radially inward side of the lateral cross members 112, as illustrated in FIGS. 3-5 and 7.

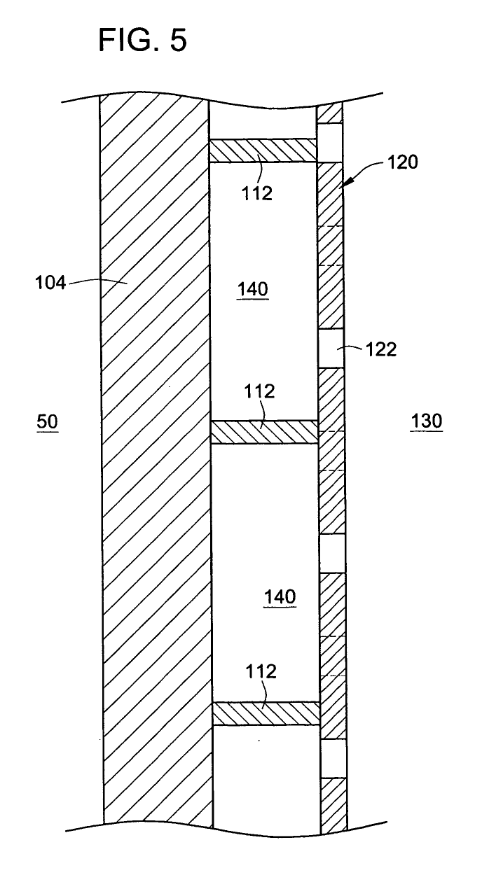

As shown in FIG. 3, in an embodiment, a flange 113 extends interiorly from each of the side panels 108 to provide support on a respective end of the cross member 112. A baffle wall 120 extends to the flange 113. The cross members 112 are mounted in a vertically spaced manner, as shown in FIGS. 4 and 5. An inward flange 115 retains the inner wall 102 between flange 113 and inward flange 115.

As will be recognized to those of ordinary skill in the art, the screen members 104 of the inner wall 102 may be constructed of a material known as profile wire. In an embodiment wherein the screen members 104 are constructed of profile wire, which has a generally triangular or trapezoidal cross-section. Each of the screen members 104 is mounted so that the profile tapers more narrowly toward the interior of the inlet distributor member 100. The triangular or trapezoidal cross-section resists the lodging of catalyst particles between adjacent segments of the profile wire. Similarly, at least a portion of the outlet pipe 38 (FIG. 1) is constructed to have openings to permit the passage of fluid from the catalyst bed to an interior of the outlet pipe but preventing passage of catalyst particles, and accordingly, the outlet pipe 38 also may be constructed of profile wire.

Turning back to FIG. 1, one or more brackets 24 are configured to hold lower ends of the inlet distributor members 100 securely relative to the reactor vessel 12. An upper portion of the reactor 10 includes an outer shield 26 that extends between the barriers 111 of the distributor members 100. A manway 30 in the shield 26 provides access to an interior of the shield 26. An inlet chamber 32 is provided between the outer shield 26 and the top head 17 of the vessel which is in communication with the main inlet duct 16. An inner shroud 34 is disposed within and under the outer shield 26 and is above the central outlet pipe 38. The inner shroud 34 comprises a cylindrical wall 33 and a cover 35. A bracket member 44 secures a top 45 of the central outlet pipe 38 for transporting purposes.

In operation, reactant fluids such as a reactant gas flows through the inlet duct 16 into the inlet chamber 32 of the reactor vessel 12. The outer shield 26 directs the fluid into the distributor ports 110 of the inlet distributor member 100. The barriers 111 prevent fluid from passing axially into the catalyst bed 50 through a top catalyst surface 54. The annular array of the inlet distributor members 100 distributes the reactant fluid along the height of the inlet distribution members. The fluid is then distributed through the baffle wall 120 into an outer surface of the annular catalyst bed 50. The fluid reactants undergo a reaction in the catalyst bed 50 and then effluent passes through the fluid-permeable screen wall the central outlet pipe 38. Effluent descends through the central outlet pipe 38 to the main outlet duct 46 to be recovered from the reactor vessel 12.

In accordance with an aspect of the invention, means are provided to reduce a pressure gradient along a length of the screen wall of the inlet. For example, according to an embodiment, a perforated baffle wall is positioned between the outer wall and screen wall and divides the interior of the inlet distributor member. The baffle wall is spaced radially inwardly from the outer wall to define a first inlet chamber for guiding fluid flow in a generally axial direction along a vertical length of the inlet member. The baffle wall is spaced from the screen wall in a radial outward direction to define a second inlet chamber for guiding fluid flow from the first inlet chamber in a generally radial direction from the baffle wall toward the screen wall. The baffle wall is effective to reduce drag caused by cross members that support the screen members.

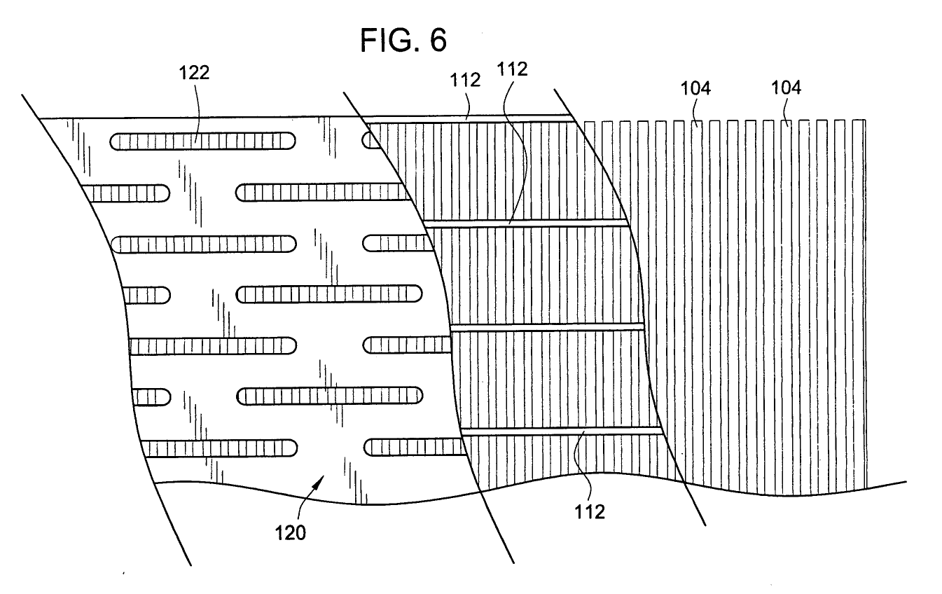

The baffle wall 120 is illustrated in greater detail in FIGS. 3-6. In the illustrated embodiment, the baffle wall 120 is constructed of a metal plate that opposes the inner wall 102 in a spaced apart manner. In particular, the baffle wall 120 is mounted to a radially outward side of the cross members 112 within the interior of the inlet distributor member 100. The baffle wall 120 extends substantially at least along the height dimension of the screen members 104. The baffle wall 120 divides the interior of the inlet distributor member 100 into a first chamber 130 on a radially outward side of the baffle wall and a second chamber 140 on a radially inward side of the baffle wall. An array of holes or perforations 122 are disposed in the baffle wall 120 to permit fluid communication between the first chamber 130 and the second chamber 140. The baffle wall 120 is preferably concentric about the central axis A (FIG. 1) of the reactor 10 (FIG. 1).

The baffle wall 120 provides a physical separation between the first chamber 130 in order to prevent axial flow resistance by the cross members 112. The physical separation of the baffle wall 120 allows smooth axial flow in the first chamber 130. The perforations 122 permit radially-directed flow from the first chamber 130 to the second chamber 140 between the cross members 112, eliminating substantial axial flow within the second chamber 140. The baffle wall 120 prevents the cross members 112 from resisting flow in the first chamber 130, and as a result, a pressure gradient along a height of the first chamber 130 is reduced.

The perforations may be provided in variety of shapes, sizes, and patterns. For example, in the embodiment illustrated in FIGS. 2-7, the perforations 122 are generally slot-shaped and are arranged in a plurality of rows. In order to promote a definite change in flow direction from an axial direction in the first chamber 130 to a radial direction in the second chamber 140 as the fluid passes through the perforations, each of the slot-shaped perforations 122 is preferably oriented transversely to the axial flow direction within the first chamber 130. Suitable performance may be yielded in an embodiment wherein the baffle wall 120 has an area that is about 20-25% open with perforations, wherein each of the slot-shaped perforations 122 is about 1 mm by about 12-13 mm, and wherein the perforations 122 are arranged in parallel rows vertically separated by increments of about 3.2 mm as measured from center-to-center of the respective rows. The baffle wall 120 may be constructed of a thin metal sheet, such as 18 gauge stainless steel. Circular shaped perforations 122 are also contemplated without limitation.

In order to avoid coking between adjacent inlet distributor members 100, it is desirable to facilitate venting of vapor between the respective side panels 108. To provide appropriate spacing for venting, as illustrated in FIG. 3, a plurality of standoffs 150 are mounted between the opposing side panels 108 to form a gap 155 between respectively adjacent inlet distributor members 100. Preferably, the standoffs 150 are spaced vertically at even increments near a radially outward edge of the side panels 108. On the radially inward side of the of the inlet distributor members 100 a corner standoff 160 may be used to maintain the gap 155 between respectively adjacent inlet distributor members 100. In order to permit vapor to communicate between the gap 155 and the catalyst bed 50, the corner standoff 160 may be perforated with an array of small openings therein. The corner standoff 160 may be a V-sectioned strip mounted to extend along a length of the gap at the radial inward corner of the inlet distributor members 100. The corner standoff 160 may be seal welded or tack welded to the neighboring inlet distributor members 100 during assembly of the reactor 10. Preferably, an inner surface of one leg of the V-sectioned strip of the corner standoff 160 is secured to the radially inner surface of inward flange 115 and an outer surface of another leg of the V-sectioned strip of the corner standoff 160 is secured to an outer surface of side wall 108 between flange 113 and inward flange 115 of an adjacent inlet distributor member 100. The gap 155 formed by the standoffs 150 advantageously permits vapor to vent the gap 155, thereby reducing coking effects at the side panels 108.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

1: A radial flow reactor comprising:
a vessel having a cylindrical vessel wall, the vessel having a central axis;
an outlet pipe within said vessel positioned generally along the axis, said outlet pipe including openings dimensioned to allow passage of fluid and prevent passage of catalyst particles;
a series of inlet distributor members disposed peripherally around an interior side of the cylindrical vessel wall; and
at least one bed chamber between said inlet distributor members and said outlet pipe for containing catalyst particles;
wherein each of the inlet distributor members includes:
a screen wall adjacent to the catalyst bed;
an outer wall generally opposed to the screen wall and spaced radially outwardly from the screen wall; and
a baffle wall positioned between the outer wall and screen wall, the baffle wall including a plurality of perforations permitting fluid communication through the baffle wall, the baffle wall being spaced radially inwardly from the outer wall to define a first inlet chamber for guiding fluid flow in a generally axial direction along the inlet member, the baffle wall being spaced radially outwardly from the screen wall to define a second inlet chamber for guiding fluid flow from the first inlet chamber in a generally radial direction from the baffle wall toward the screen wall.

2: The radial flow reactor of claim 1, wherein the baffle wall is generally concentric about a central axis of the reactor.

3: The radial flow reactor of claim 1, wherein the perforations are generally slot-shaped.

4: The radial flow reactor of claim 3, wherein each of the slot-shaped perforations has a length oriented generally perpendicular to an axial direction.

5: The radial flow reactor of claim 4, wherein each of the slot-shaped perforations has a width of about 1 mm.

6: The radial flow reactor of claim 1, wherein standoffs space adjacent inlet distributor members from each other.

7: The radial flow reactor of claim 1, wherein a V-sectioned standoff spaces adjacent inlet distributor members from each other.

8: The radial flow reactor of claim 1, wherein each of the inlet distributors further includes a pair of opposed side panels extending between the screen and the outer wall and a plurality of transverse cross bars extending between the side panels, each of the bars having a radially outward edge, the baffle wall mounted to the radially outward edges of the respective cross bars.

9: The radial flow reactor of claim 8, wherein each of the cross bars has a radially inward edge, the screen wall mounted to the radially inward edges of the respective cross bars.

10: The radial flow reactor of claim 8, wherein each of the inlet distributors includes at least one flange extending interiorly from each of the side panels, an edge of the perforated baffle wall being mounted to the flange.

11: The radial flow reactor of claim 1, wherein each of the inlet distributor members further comprises an inlet at an end of the distributor that directs fluid into the first inlet chamber.

12: A radial flow reactor comprising:
a vessel having a cylindrical vessel wall, the vessel having a central axis;
a plurality of elongate inlet distributor members, each of the distributor members being generally disposed parallel to the axis, the plurality of distributor member mounted peripherally around an interior of the vessel wall;
an outlet pipe positioned generally along the axis to define bed chamber between the outlet pipe and the inlet distributor members, said outlet pipe including openings dimensioned to allow passage of fluid and prevent passage of catalyst particles; and
at least one bed chamber concentrically between said inlet distributor members and said center outlet pipe for containing catalyst particles;
wherein each of the inlet distributor members includes:
an elongate body defining an interior, at least a portion of the body including a screen wall facing the bed chamber, the screen wall constructed of a screen wall members spaced apart by openings dimensioned to permit the outward passage of fluid to the catalyst bed and to prevent the passage of catalyst particles;
an inlet at an end of the body to introduce fluid into the interior; and
means for reducing a pressure gradient along the screen as fluid flows from the inlet through the interior.

13: The radial flow reactor of claim 12, wherein said means for reducing a pressure gradient comprises a perforated baffle wall mounted to the body to extend across the interior, the baffle wall being spaced in a radially outward direction from the screen wall.

14: The radial flow reactor of claim 13, wherein said baffle wall separates the interior into a first inlet chamber for guiding fluid flow in a generally axial direction from the inlet, the baffle wall including perforations that guide fluid flow in a generally radial direction from the first inlet chamber toward the screen wall.

15: The radial flow reactor of claim 14, wherein the screen wall includes a plurality of screen members, and a plurality of lateral cross members, each of the cross members mounted to the elongate body and supporting a radially outward side of the screen members.

16: The radial flow reactor of claim 15, wherein the cross members are positioned at spaced intervals generally along a height of the inlet distributor member.

17: The radial flow reactor of claim 16, wherein the baffle wall is mounted to a radially outward side of the cross members.

18: The radial flow reactor of claim 17, wherein said means is effective to reduce flow resistance of the cross members in an axial direction.

19: A method for reacting a fluid with a catalyst comprising the steps of:
providing a cylindrical reactor vessel having a central outlet pipe positioned generally along on a central axis, at least one elongate inlet distributor member spaced radially outwardly from the outlet pipe to define a catalyst bed chamber between the outlet pipe and the inlet distributor member, the distributor member having a screen wall facing the catalyst bed chamber;
delivering a fluid to a first inlet chamber within the inlet distributor member, the first inlet chamber extending substantially along an axial length of the distributor member,
passing the fluid in a generally radial direction through perforations in a baffle wall to at least one second inlet chamber within the inlet distributor member;
passing the fluid in a generally radial direction through openings in the screen wall into the catalyst bed;
contacting fluid with catalyst in said catalyst bed to yield a treated fluid; and
recovering the treated fluid from said catalyst bed through said central outlet pipe.

20: The method of claim 19 wherein the screen wall includes a plurality of cross members, whereby the step of passing the fluid in a generally radial direction includes passing the fluid between the cross members.
